(19) United States
(12) Patent Application Publication
(10) Pub. No.: US 2021/0195134 A1
(43) Pub. Date: Jun. 24, 2021

(54) METHOD AND DEVICE FOR GENERATING DYNAMIC IMAGE, MOBILE PLATFORM, AND STORAGE MEDIUM

(71) Applicant: SZ DJI TECHNOLOGY CO., LTD., Shenzhen (CN)

(72) Inventor: Tao WANG, Shenzhen (CN)

(21) Appl. No.: 17/190,364

(22) Filed: Mar. 2, 2021

Related U.S. Application Data
(63) Continuation of application No. PCT/CN2018/103737, filed on Sep. 3, 2018.

(51) Int. Cl. H04N 5/44; G11B 27/034; G11B 27/34; H04N 5/77; H04N 19/172; H04N 7/01; G06T 3/40

(52) U.S. Cl. CPC H04N 5/4448; G11B 27/034; G11B 27/34; G06T 3/40; H04N 19/172; H04N 7/0102; H04N 5/772

(57) ABSTRACT

A method for generating a dynamic image includes obtaining video data output by a shooting device carried by a mobile platform and performing image conversion on the video data to generate the dynamic image corresponding to at least a part of the video data.

### CROSS-REFERENCE TO RELATED APPLICATION

This application is a continuation of International Application No. PCT/CN2018/103737, filed Sep. 3, 2018, the entire content of which is incorporated herein by reference.

### TECHNICAL FIELD

The present disclosure relates to the field of image processing technology and, in particularly, to a method and device for generating dynamic image, a mobile platform, and a storage medium.

### BACKGROUND

The Graphics Interchange Format (GIF) is a bitmap graphics file format that reproduces true color images in 8-bit colors (that is, 256 colors). GIF is actually a second-frame dynamic image animation in a two-dimensional silent pixel dot matrix format. It has the characteristics of high compression ratio and cannot store more than 256 color images. It is currently one of the formats widely used in the World Wide Web for transmission of images in network.

Most of the image data captured by the existing unmanned aerial vehicles is video image data. Compared with GIF images, the video has sound and the color experience is almost unlimited. However, in the application of the image data, the use of the video image data on the Internet is more restrictive, which has poor compatibility and less dissemination power, thereby reducing the convenience and flexibility of the use of image data by the user.

### SUMMARY

In accordance with the disclosure, there is provided a method for generating a dynamic image including obtaining video data output by a shooting device carried by a mobile platform and performing image conversion on the video data to generate the dynamic image corresponding to at least a part of the video data.

Also in accordance with the disclosure, there is provided a dynamic image generation device including a memory storing a computer program, and a processor used to execute the computer program to obtain video data output by a shooting device carried by a mobile platform and perform image conversion on the video data to generate a dynamic image corresponding to at least a part of the video data.

### BRIEF DESCRIPTION OF THE DRAWINGS

FIG. 1 is a schematic flowchart of an example method for generating a dynamic image consistent with embodiments of the disclosure.

FIG. 2 is the schematic flowchart of an example method of performing image conversion processing on video data to generate a dynamic image corresponding to at least a part of the video data consistent with the embodiments of the disclosure.

FIG. 3 is a schematic flowchart showing obtaining at least two frames of static image from a static image group consistent with embodiments of the disclosure.

FIG. 4 is a schematic flowchart of an example method of performing encoding processing on at least two frames of static image to generate a dynamic image consistent with embodiments of the disclosure.

FIG. 5 is a schematic flowchart showing performing encoding processing on at least two frames of static image to generate a dynamic image according to an image size and a target size consistent with embodiments of the disclosure.

FIG. 6 is a schematic flowchart of another example method of performing encoding processing on at least two frames of static image to generate a dynamic image consistent with embodiments of the disclosure.

FIG. 7 is a schematic flowchart of another example method for generating a dynamic image consistent with embodiments of the disclosure.

FIG. 8 is a schematic flowchart showing performing interception processing on video data consistent with embodiments of the disclosure.

FIG. 9 is a schematic structural diagram of an example dynamic image generation device consistent with embodiments of the disclosure.

FIG. 10 is a schematic structural diagram of another example dynamic image generation device consistent with embodiments of the disclosure.

FIG. 11 is a schematic structural diagram of a mobile platform consistent with embodiments of the disclosure.

### DETAILED DESCRIPTION OF THE EMBODIMENTS

Technical solutions in the embodiments of the present disclosure will be described clearly and completely in detail with reference to the drawings below, to make the objectives, technical solutions, and advantages of the embodiments of the present disclosure clearer. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

Unless otherwise specified, all the technical and scientific terms used herein have the same or similar meanings as generally understood by one of ordinary skill in the art. As described herein, the terms used in the specification of the present disclosure are intended to describe example embodiments, instead of limiting the present disclosure.

The embodiments of the present disclosure are described in detail with reference to the drawings below. Provided that there is no conflict between the embodiments, the following embodiments and the features in the embodiments can be combined with each other.

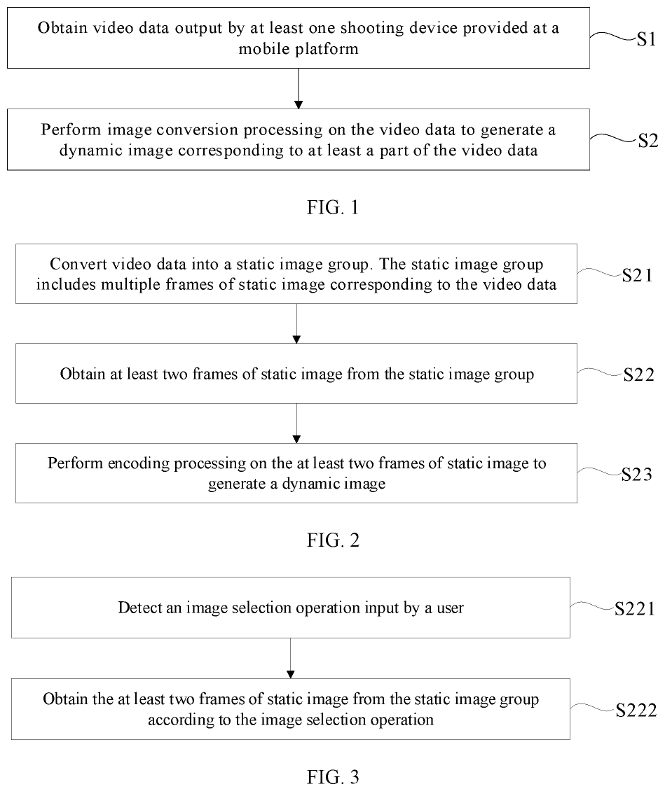

FIG. 1 is a schematic flowchart of an example method for generating a dynamic image consistent with embodiments of the disclosure. As shown in FIG. 1, the method for generating a dynamic image includes the following processes.

At S1, video data output by at least one shooting device provided at a mobile platform is obtained.

The video data can be video data in AVI, wma, MP4, flash, or another format generated by compression of multiple image frames. The mobile platform can include at least one of an unmanned aerial vehicle, an unmanned ships, or an unmanned vehicle. In some embodiments, the mobile platform can include a device movable by external force, such as a handheld device, e.g., a handheld gimbal. One or more shooting devices can be carried by the mobile platform. The shooting directions of multiple shooting devices can be different from cause each shooting device to output video data of a range of view angle, or can be same as cause multiple shooting devices to output video data of a same range of view angle.

At S2, image conversion processing is performed on the video data to generate a dynamic image corresponding to at least a part of the video data.

The dynamic image can be a GIF image. The image conversion processing on video data can be performed after the video data is obtained, to cause the video data to be converted into a corresponding dynamic image. In some embodiments, when the amount of storage data of the video data is large, image conversion processing on a part of the video data can be performed to obtain a dynamic image corresponding to the part of the video data, to improve the quality and efficiency of obtaining the dynamic image. When the amount of storage data of the video data is small, image conversion processing can be performed on the whole video data to obtain a dynamic image corresponding to the whole video data.

In the method for generating a dynamic image consistent with the disclosure, obtaining at least a dynamic image corresponding to at least a part of the video data via image conversion processing on the video data can solve the problem of limitation on the use of video image data on the Internet in the existing technology, improve the compatibility of image data, and expand the dissemination of image data, thereby ensuring the convenience and flexibility in using image data by user, effectively improving the practicability of the method, and conducive to market promotion and application.

FIG. 2 is a schematic flowchart of an example method of performing image conversion processing on video data to generate a dynamic image corresponding to at least a part of the video data consistent with the embodiments of the disclosure. FIG. 3 is a schematic flowchart showing obtaining at least two frames of static image from a static image group consistent with embodiments of the disclosure. As shown in FIG. 2, in some embodiments, performing image conversion processing on video data to generate a dynamic image corresponding to at least a part of the video data includes the following processes.

At S21, video data is converted into a static image group. The static image group can include multiple frames of static image corresponding to the video data.

Because the video data essentially includes continuously played static images, the video data can be converted into a corresponding group of static images. In the conversion process, because the video data has a sound attribute while the static image group has no sound attribute, the sound attribute can be first removed from the video data, and then the video data without the sound attribute can be converted into the corresponding group of static images.

At S22, at least two frames of static image are obtained from the static image group.

In some embodiments, as shown in FIG. 3, obtaining the at least two frames of static image from the static image group (S22) includes detecting an image selection operation input by a user (S221), and obtaining the at least two frames of static image from the static image group according to the image selection operation (S222).

In some embodiments, the image selection operation input by a user can be that a user directly inputs the frame numbers of the static images. For example, the image selection operation input by the user is: selecting the 100^{th} to the 110^{th} frame, or selecting the 100^{th} frame, the 105^{th} frame, the 120^{th} frame, etc. The user can just enter the above frame numbers, and then the at least two corresponding static frames can be determined from the static image group according to the input frame numbers.

In some embodiments, the image selection operation input by the user can also be that the user directly selects the at least two frames of static image via touch operations. For example, the user can view all images in the static image group, and when it is detected the time that the user stays in a certain image exceeds a preset time threshold, or when it is detected that the user clicks or presses to select a certain image, it can be determined that the user has selected this frame of image. In this scenario, the image selection operation input by the user is a manual operation.

In some embodiments, the image selection operation input by the user can be time period information. For example, the user enters time period information, and the time period information is the 50^{th} second to the 55^{th} second, then the at least two frames of static image corresponding to the time period information can be obtained from the static image group, i.e., all the static images in the period from the 50^{th} second to the 55^{th} second can be obtained. In this scenario, the image selection operation input by the user is an operation by the user to input time period information. Similarly, the image selection operation input by the user can also be an operation of the user to input time point information. For example, the time point information input by the user is the 30^{th} second, the 35^{th} second, and the 40^{th} second, and hence the at least two frames of static image corresponding to the time point information, i.e., the three frames of static image corresponding to the 30^{th} second, the 35^{th} second, and the 40^{th} second, can be obtained from the static image group.

Referring again to FIG. 2, at S23, encoding processing is performed on the at least two frames of static image to generate a dynamic image.

After the at least two frames of static image are obtained, encoding processing can be performed on the at least two frames of static image to generate a dynamic image including the least two frames of static image.

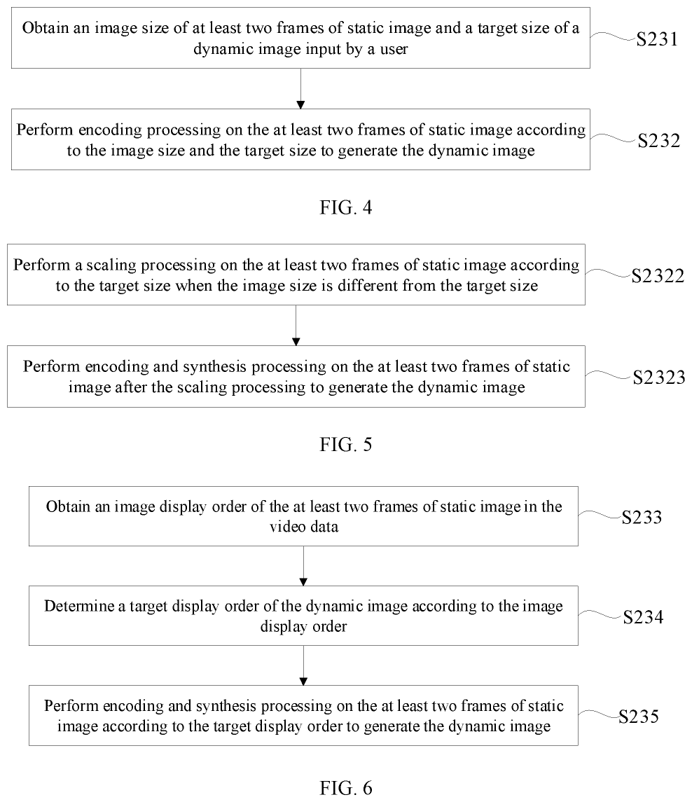

FIG. 4 is a schematic flowchart of an example method of performing encoding processing on at least two frames of static image to generate a dynamic image consistent with embodiments of the disclosure. FIG. 5 is a schematic flowchart showing performing encoding processing on at least two frames of static image to generate a dynamic image according to an image size and a target size consistent with embodiments of the disclosure. As shown in FIG. 4, in some embodiments, performing encoding processing on at least two frames of static image to generate a dynamic image includes the following processes.

At S231, an image size of at least two frames of static image and a target size of a dynamic image input by a user are obtained.

The image size of a static image can be determined according to the video data, and the target size of the dynamic image can be input and set by the user. The target size can be same as or different from the image size.

At S232, encoding processing is performed on the at least two frames of static image according to the image size and the target size to generate the dynamic image.

In some embodiments, performing encoding processing on the at least two frames of static image according to the image size and the target size to generate the dynamic image (S232) can include performing encoding and synthesis processing on the at least two frames of static image to generate the dynamic image when the image size is same as the target size.

The image size can be analyzed and compared with the target size after the image size and the target size are obtained. When the comparison result is that the image size is same as the target size, the image size can meet the need of the user, and encoding and synthesis processing can be directly performed on the at least two frames of static image using a preset encoding algorithm to generate the dynamic image.

In some other embodiments, as shown in FIG. 5, performing encoding processing on the at least two frames of static image according to the image size and the target size to generate the dynamic image (S232) includes performing scaling processing on the at least two frames of static image according to the target size when the image size is different from the target size (S2322), and performing encoding and synthesis processing on the at least two frames of static image after the scaling processing to generate the dynamic image (S2323).

When the comparison result is that the image size is different from the target size, the image size cannot meet the need of the user, and then the image size of the static image can be changed and adjusted according to the target size to meet the need of the user. In some embodiments, when the image size is larger than the target size, the static image is relatively large, the target size can be used as a standard size to shrink the static image to obtain a static image of the standard size. When the image size is smaller than the target size, the static image is relatively small, the target size can be used as the standard size to enlarge the static image to obtain a static image of the standard size.

The static image after the scaling processing can meet the need of the user for the size of the dynamic image, and encoding and synthesis processing can be performed on the at least two frames of static image using a preset coding algorithm to generate the dynamic image.

Performing above processes to generate a dynamic image can effectively ensure that the size of the dynamic image can meet the need of the user, thereby improving the stability and reliability of the method consistent with embodiments of the disclosure.

FIG. 6 is a schematic flowchart of another example method of performing encoding processing on at least two frames of static image to generate a dynamic image consistent with embodiments of the disclosure. As shown in FIG. 6, in some embodiments, performing encoding processing on the at least two frames of static image to generate the dynamic image includes the following processes.

At S233, an image display order of the at least two frames of static image in the video data is obtained.

In some embodiments, each frame of static image in the video data can correspond to a piece of time information. The image display order of a static image in the video data can be obtained according to the time information of the static image. For example, the video data includes a first static image, a second static image, and a third static image, the time information corresponding to the first, second, and third static images are 1 minute 20 seconds, 5 minutes 40 seconds, and 3 minutes 15 seconds, respectively. The image display order is then determined according to the order of the time information, that is, the first static image-the third static image-the second static image. Other manners of obtaining the image display order can be used, as long as the accuracy and reliability of obtaining the image display order can be guaranteed.

At S234, a target display order of the dynamic image is determined according to the image display order.

The image display order can be same as or different from the target display order. For example, when the image display order is the first static image-the third static image-the second static image, the target display order of the dynamic image can be the first static image-the third static image-the second static image, or can be the second static image-the third static image-the first static image, i.e., the target display order and the image display order are reversed to each other.

At S235, encoding and synthesis processing is performed on the at least two frames of static image according to the target display order to generate the dynamic image.

After the target display order is obtained, encoding and synthesis processing can be performed on the at least two frames of static image according to the target display order to generate the dynamic image.

Performing above processes to generate a dynamic image can effectively ensure that the display order of the dynamic image can meet the need of the user, thereby improving the flexibility and reliability of the method consistent with embodiments of the disclosure.

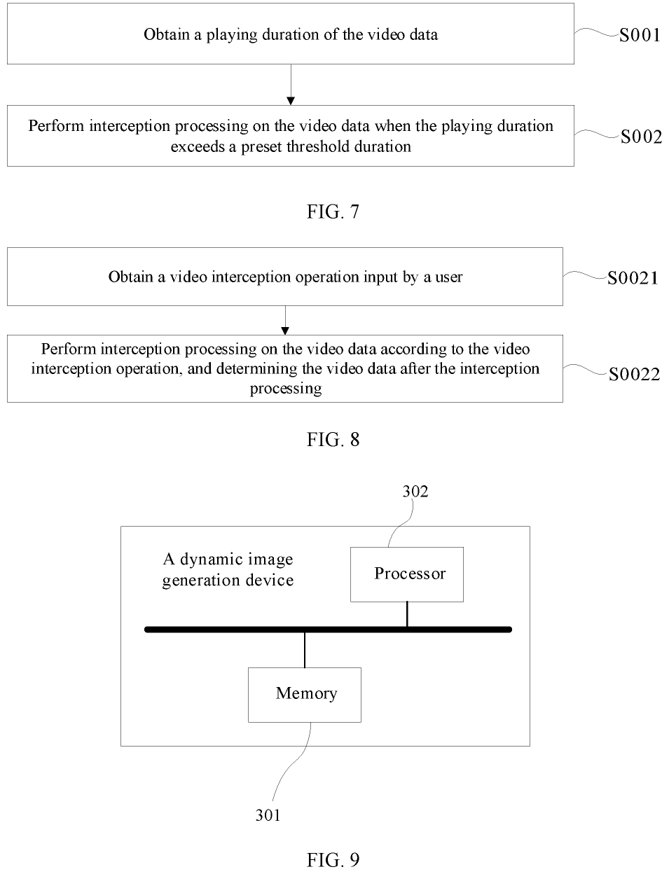

FIG. 7 is a schematic flowchart of another method for generating a dynamic image consistent with embodiments of the disclosure. FIG. 8 is a schematic flowchart showing performing interception processing on video data consistent with embodiments of the disclosure. As shown in FIG. 7, in some embodiments, the method for generating a dynamic image further includes the following processes before performing image conversion processing on the video data to improve the practicability of the method.

At S001, a playing duration of the video data is obtained.

At S002, when the playing duration exceeds a preset threshold duration, interception processing is performed on the video data.

In some embodiments, longer playing time of the video data means more static images included in the video data. When the video data is converted into a dynamic image, a playing duration of the video data can be obtained, and can be analyzed and compared with the threshold duration. When the playing duration is longer than the threshold duration, the video data may have too many static images. Generally, 1 second of video data corresponds to at least 18 frames of static image. Interception processing can be performed on the video data to ensure the efficiency and quality of the conversion of the video data. In some embodiments, as shown in FIG. 8, performing interception processing on the video data includes obtaining a video interception operation input by a user (S0021), and performing interception processing on the video data according to the video interception operation and determining the video data after the interception processing (S0022).

The video interception operation can include at least one of a period for the interception, a first frame of static image for the interception, a last frame of static image for the interception, or a number of static images for the interception.

For example, when the video interception operation input by the user is a period for interception, such as a period from 3 minutes 50 seconds to 4 minutes, the video data can be intercepted according to the above period to obtain the video data from 3 minutes 50 seconds to 4 minutes. When the video interception operation input by the user includes a first frame of static image for interception and a last frame of static image for interception, such as a first frame of static image is the 101^{st} frame, and a last frame static image is the 120^{th} frame, performing interception processing on the video data can obtain the video data including static images from the 101^{st} frame to the 120^{th} frame. When the video interception operation input by the user includes a number of static images for interception, such as 50 static images, the video data can be randomly intercepted according to the number of static images, to obtain video data including 50 static images.

After the video interception operation, conversion processing can be performed on the intercepted video data to generate the dynamic image, thereby effectively improving the efficiency and quality of generating the dynamic image, and improving the stability and reliability of the method consistent with embodiments of the disclosure.

In some embodiments, the mobile platform can be an unmanned aerial vehicle. Corresponding video data can be generated and output after a shooting device carried by the unmanned aerial vehicle recorded a video. The video data can be obtained via a wired or a wireless communication connected to the shooting device, and then can be converted into a GIF dynamic image of a selected size. During the conversion processing on the video data, an adjustment operation such as scaling, compression, and/or color approximation to 8-bit color can be performed on the video data according to the selected target size of the GIF dynamic image. Further, the shooting device can be directly controlled to shoot and output a dynamic image, instead of performing conversion processing on the video data.

Converting video data into a dynamic image can effectively improve the compatibility of image data, can make it convenient for user to use and spread the image data, can effectively improve the practicability of the method to generate a dynamic image, and can make it conducive for market promotion and application.

FIG. 9 is a schematic structural diagram of an example dynamic image generation device consistent with embodiments of the disclosure. The dynamic image generation device can execute a method consistent with the disclosure, such as one of the above-described example methods for generating a dynamic image. As shown in FIG. 9, the dynamic image generation device includes a memory 301 for storing a computer program, and a processor 302 configured to execute the computer program stored in the memory 301 to obtain video data output by at least one shooting device provided at a mobile platform, and perform image conversion processing on the video data to generate a dynamic image corresponding to at least a part of the video data.

In some embodiments, the dynamic image can be a GIF image. The mobile platform can include at least one of an unmanned aerial vehicle, an unmanned ship, or an unmanned vehicle.

In some embodiments, when the processor 302 performs image conversion processing on the video data to generate the dynamic image corresponding to the at least a part of the video data, the processor 302 specifically converts the video data into a static image group including multiple frames of static image corresponding to the video data, obtains at least two frames of static image from the static image group, and performs encoding processing on the at least two frames of static image to generate the dynamic image.

In some embodiments, when the processor 302 obtains at least two frames of static image from the static image group, the processor 302 specifically detects an image selection operation input by a user, and obtains at least two frames of static image from the static image group according to the image selection operation.

In some embodiments, when the processor 302 performs encoding processing on the at least two frames of static image to generate the dynamic image, the processor 302 specifically obtains an image size of the at least two frames of static image and a target size of a dynamic image input by a user, and performs encoding processing on the at least two frames of static image according to the image size and the target size to generate the dynamic image.

In some embodiments, when the processor 302 performs encoding processing on the at least two frames of static image according to the image size and the target size to generate the dynamic image, the processor 302 specifically performs encoding and synthesis processing on the at least two frames of static image to generate the dynamic image when the image size is same as the target size.

In some embodiments, when the processor 302 performs encoding processing on the at least two frames of static image according to the image size and the target size to generate the dynamic image, the processor 302 specifically performs scaling processing on the at least two frames of static image according to the target size when the image size is different from the target size, and performs encoding and synthesis processing on the at least two frames of static image after the scaling processing to generate the dynamic image.

In some embodiments, when the processor 302 performs encoding processing on the at least two frames of static image to generate the dynamic image, the processor 302 specifically obtains an image display order of the at least two frames of static image in the video data, determines a target display order for the dynamic image according to the image display order, and performs encoding and synthesis processing on the at least two frames of static image according to the target display order to generate the dynamic image.

The image display order can be same as or different from the target display order.

In some embodiments, the processor 302 is also configured to obtain a playing duration of the video data before performing the image conversion processing on the video data, and to perform interception processing on the video data when the playing duration exceeds a preset threshold duration.

In some embodiments, when the processor 302 performs interception processing on the video data, the processor 302 specifically obtains a video interception operation input by a user, performs interception processing on the video data according to the video interception operation, and determines the video data after the interception processing.

The video interception operation can include at least one of a period for the interception, a first frame of static image for the interception, a last frame of static image for the interception, or a number of static images for the interception.

The dynamic image generation device consistent with above embodiments can be used to execute a method consistent with the disclosure, such as one of the example methods described above in connection with FIG. 1 to FIG. 8. The specific execution method and beneficial effect are similar, and the detail is not repeated here.

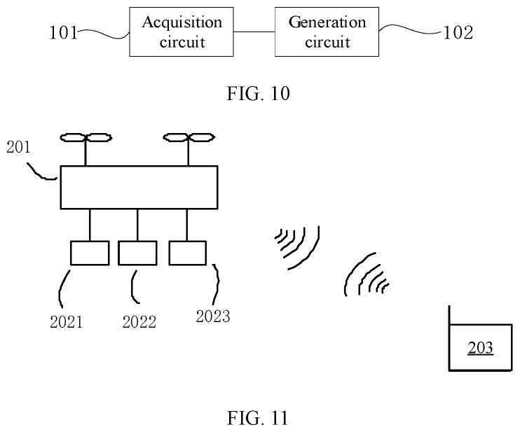

FIG. 10 is a schematic structural diagram of another example dynamic image generation device consistent with embodiments of the disclosure. The dynamic image generation device can execute a method consistent with the disclosure, such as one of the above-described example methods for generating a dynamic image. As shown in FIG. 10, the dynamic image generation device includes an acquisition circuit 101 configured to obtain video data output by at least one shooting device provided at a mobile platform, and a generation circuit 102 configured to perform image conversion processing on the video data to generate a dynamic image corresponding to at least a part of the video data.

The acquisition circuit 101 and the generation circuit 102 of the dynamic image generation device consistent with above embodiments can be used to execute a method consistent with the disclosure, such as one of the example methods described above in connection with FIG. 1 to FIG. 8. Detailed descriptions are omitted and references can be made to the descriptions of the example methods.

FIG. 11 is a schematic structural diagram of a mobile platform consistent with embodiments of the disclosure. The mobile platform 201 can include at least one of an unmanned aerial vehicle, an unmanned ships, or an unmanned vehicle. The mobile platform 201 can include at least one shooting device for outputting video data, a dynamic image generation device consistent with the disclosure, such as one of the above-described example dynamic image generation devices (e.g., the one shown in FIG. 9), and a generation device 203 configured to receive video the data output by the shooting device.

For example, as shown in FIG. 11, the at least one shooting device includes a shooting device 2021, a shooting device 2022, and a shooting device 2023. The generating device 203 can receive the video data output by the shooting device 2021, the shooting device 2022, and the shooting device 2023, and can convert the video data into a corresponding dynamic image.

The specific implementation principle and implementation effect of the mobile platform consistent with above embodiments are consistent with those of the dynamic image generation device consistent with the disclosure, such as one of the above-described example dynamic image generation devices (e.g., the one shown in FIG. 9). Detailed descriptions are omitted and references can be made to the descriptions above.

The present disclosure also provides a computer-readable storage medium storing program instructions configured to implement a dynamic image generation method consistent with the disclosure, such as one of the example methods described above in connection with FIG. 1 to FIG. 8.

The technical solutions and features consistent with the above embodiments can be singly or combined in case of conflict with the present disclosure. As long as they do not exceed the cognitive scope of those skilled in the art, they all belong to the equivalent embodiments within the scope of this disclosure.

In some embodiments of present disclosure, it should be understood that the related device and method disclosed may be implemented in other manners. For example, the embodiments of the device described above are merely illustrative. The division of the modules or units may only be a logical function division, and there may be other divisions in actual implementation. For example, multiple units or components may be combined or may be integrated into another system, or some features can be ignored or not executed. Further, the coupling or direct coupling or communication connection shown or discussed may include a direct connection or an indirect connection or communication connection through one or more interfaces, devices, or units, which may be electrical, mechanical, or in other form.

The unit described as separate components may or may not be physically separated, and a component shown as a unit may or may not be a physical unit. That is, the units may be located in one place, or may be distributed over a plurality of network elements. Some or all units may be selected according to actual needs to achieve the objective of the embodiments.

In addition, the functional units in the various embodiments of the present invention may be integrated in one processing unit, or each unit may be an individual physically unit, or two or more units may be integrated in one unit. The above-mentioned integrated unit can be implemented in the form of hardware or software functional unit.

A method consistent with the disclosure can be implemented in the form of computer program stored in a non-transitory computer-readable storage medium, which can be sold or used as a standalone product. The computer program can include instructions that enable a computer processor to perform part or all of a method consistent with the disclosure. The storage medium can be any medium that can store program codes, for example, a USB disk, a mobile hard disk, a read-only memory (ROM), a random-access memory (RAM), a magnetic disk, or an optical disk.

It is intended that the above embodiments be considered as examples only and not to limit the scope of the present disclosure. Any equivalent changes on structures or processes, or directly or indirectly applications in other related technical field of the above embodiments are within the scope of the present disclosure.

Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. A method for generating a dynamic image comprising:
obtaining video data output by a shooting device carried by a mobile platform; and
performing image conversion on the video data to generate the dynamic image corresponding to at least a part of the video data.

2. The method of claim 1, wherein performing the image conversion on the video data to generate the dynamic image includes:
converting the video data into a static image group including a plurality of static images corresponding to the video data;
obtaining at least two static images from the static image group;
performing encoding on the at least two static images to generate the dynamic image.

3. The method of claim 2, wherein obtaining the at least two static images from the static image includes:
detecting an image selection operation input by a user; and
obtaining the at least two static images from the static image group according to the image selection operation.

4. The method of claim 2, wherein:
obtaining the at least two static images from the static image includes obtaining an image size of the at least two static images and a target size for the dynamic image input by a user; and
performing the encoding on the at least two static images includes performing the encoding on the at least two static images according to the image size and the target size to generate the dynamic image.

5. The method of claim 4, wherein performing the encoding on the at least two static images according to the image size and the target size includes:
performing encoding and synthesis on the at least two static images to generate the dynamic image in response to the image size being same as the target size.

6. The method of claim 4, wherein performing the encoding on the at least two static images according to the image size and the target size includes, in response to the image size being different from the target size:
performing scaling on the at least two static images according to the target size to generate at least two scaled static images; and
performing encoding and synthesis on the at least two scaled static images to generate the dynamic image.

7. The method of claim 2, wherein performing the encoding on the at least two static images includes:
obtaining an image display order of the at least two static images in the video data;
determining a target display order for the dynamic image according to the image display order; and
performing encoding and synthesis on the at least two static images according to the target display order to generate the dynamic image.

8. The method of claim 2, further comprising, before performing the image conversion on the video data:
obtaining a playing duration of the video data; and
performing interception on the video data in response to the playing duration exceeding a threshold duration.

9. The method of claim 8, wherein performing the interception on the video data includes:
obtaining a video interception operation input by a user; and
performing the interception on the video data according to the video interception operation to obtain intercepted video data.

10. The method of claim 9, wherein the video interception operation includes at least one of a period for the interception, a first static image for the interception, a last static image for the interception, or a number of static images for the interception.

11. The method of claim 1, wherein the dynamic image includes a GIF image.

12. A dynamic image generation device comprising:
a memory storing a computer program; and
a processor configured to execute the computer program to:
obtain video data output by a shooting device carried by a mobile platform; and
perform image conversion on the video data to generate a dynamic image corresponding to at least a part of the video data.

13. The device of claim 12, wherein the processor is further configured to execute the computer program to:
convert the video data into a static image group including a plurality of static images corresponding to the video data;
obtain at least two static images from the static image group; and
perform encoding on the at least two static images to generate the dynamic image.

14. The device of claim 13, wherein the processor is further configured to execute the computer program to:
detect an image selection operation input by a user; and
obtain the at least two static images from the static image group according to the image selection operation.

15. The device of claim 13, wherein the processor is further configured to execute the computer program to:
obtain an image size of the at least two static images and a target size of the dynamic image input by a user; and
perform the encoding on the at least two static images according to the image size and the target size to generate the dynamic image.

16. The device of claim 15, wherein the processor is further configured to execute the computer program to:
perform encoding and synthesis on the at least two static images to generate the dynamic image in response to the image size being same as the target size.

17. The device of claim 15, wherein the processor is further configured to execute the computer program to, in response to the image size being different from the target size:
perform scaling on the at least two static images according to the target size; and
perform encoding and synthesis on the at least two scaled static images to generate the dynamic image.

18. The device of claim 13, wherein the processor is further configured to execute the computer program to:
obtain an image display order of the at least two static images in the video data;
determine a target display order for the dynamic image according to the image display order; and
perform encoding and synthesis on the at least two static images according to the target display order to generate the dynamic image.

19. The device of claim 13, wherein the processor is further configured to, before perform image conversion on the video data:
obtain a playing duration of the video data; and
perform interception on the video data in response to the playing duration exceeding a preset threshold duration.

20. The device of claim 19, wherein the processor is further configured to:
obtain a video interception operation input by a user; and
perform interception on the video data according to the video interception operation to obtain intercepted video data.
